(19) United States
(12) Patent Application Publication
(10) Pub. No.: US 2024/0330245 A1
(43) Pub. Date: Oct. 3, 2024

(54) DISTRIBUTED DATASTORE FOR SCALE-OUT DATA STORAGE SYSTEM

(71) Applicant: QUANTUM CORPORTION, Centenial, CO (US)

(72) Inventors: Ben Jarvis, Stillwater, MN (US); Stephen P. Lord, Lakeville, MN (US)

(21) Appl. No.: 18/624,341

(22) Filed: Apr. 2, 2024

Related U.S. Application Data
(60) Provisional application No. 63/592,863, filed on Oct. 24, 2023.
(60) Provisional application No. 63/456,762, filed on Apr. 3, 2023.
(60) Provisional application No. 63/456,524, filed on Apr. 2, 2023.

(51) Int. Cl. G06F 16/182; G06F 16/16

(52) U.S. Cl. CPC G06F 16/1827; G06F 16/164

(57) ABSTRACT

Distributed scale-out data storage system operating a distributed scale-out datastore library and various software modules and libraries thereon. The distributed scale-out datastore library and various software modules and additional libraries enable enhanced data management efficiencies and methods for performing data management tasks. In various embodiments, at least three storage nodes (270, 272, 274), each storage node further comprised of a storage server (240a-240z) configured to connect to a storage client (260) over a network interface (212), a target server (223a-223z) connected to a plurality of storage drives (220a-220z); a processor complex (140), and a memory (130), wherein the memory (130, 132) has a plurality of logic modules and plurality of libraries stored thereon that are executable by the processor complex (140) to perform data storage management operations, a coordinator program (230) and a data fabric (250).

### RELATED APPLICATIONS

This application claims priority on U.S. Provisional Application Ser. No. 63/456,524, filed on Apr. 2, 2023, and entitled, “SCALABLE DATA STORAGE SYSTEMS AND METHODS,” U.S. Provisional Application Ser. No. 63/456,762, filed on Apr. 3, 2023, and entitled, “SCALABLE DATA STORAGE SYSTEMS AND METHODS,” and U.S. Provisional application Ser. No. 63/592,863, filed on Nov. 1, 2023, and entitled, “SCALABLE DATA STORAGE SYSTEMS AND METHODS;” U.S. patent application Ser. No. ______, entitled “SYSTEM AND METHOD FOR KEY-VALUE SHARD CREATION AND MANAGEMENT IN A KEY-VALUE STORE” filed concurrently herewith; and U.S. patent application Ser. No. ______, entitled “ERASURE ENCODING USING ZONE SETS,” filed concurrently herewith. As far as permitted, the contents of U.S. Provisional Application Ser. Nos. 63/456,524, 63/456,762, and 63/592,863 and United States patent application Nos. ______ and ______ are incorporated in their entirety herein by reference.

### BACKGROUND

End users of data storage products are required to manage and store rapidly growing volumes of data in data storage systems. Many of these data storage systems are built on proprietary hardware running proprietary software. The proprietary nature of these systems makes it difficult and expensive to upgrade to achieve better system performance because changing one component within the tightly integrated hardware and software cluster has a cascading effect that becomes time and cost prohibitive. As a result, many data storage systems are running on outdated, purpose-built hardware, which results in sub-par system performance. Looking to the future, with the intensive compute capabilities promised by innovations such as artificial intelligence and machine learning, these shortcomings become even more critical. It is, therefore, desirable to design a data storage software suite capable of achieving these optimizations, not only today, but over time as optimizations evolve, running on a wide variety of scalable data storage hardware platforms.

### SUMMARY

The present invention is directed toward a distributed, scale-out data storage system. In various embodiments, the distributed, scale-out data storage system comprises at least three storage nodes, a coordinator program, and a data fabric. Each storage node can be further comprised of a storage server configured to connect to a storage client over a network interface, a target server connected to a plurality of storage drives, a processor complex, and a memory, wherein the memory has a plurality of logic modules and a plurality of libraries stored thereon and executable by the processor complex to perform data storage management operations.

In certain embodiments, the plurality of storage drives are non-volatile memory express (NVMe) flash drives.

In some embodiments, the storage server is further comprised of a presentation module, a filesystem library, a datastore library, and a transport library.

In various embodiments, the target server is further comprised of a storage module, and a transport library.

In certain embodiments, the coordinator program is further comprised of a coordinator module, and a transport library.

In some embodiments, one or more of the plurality of logic modules or the plurality of libraries forms a Kubernetes pod.

In various embodiments, the target module coordinates access to individual storage drives within the plurality of storage drives.

In certain embodiments, the coordinator module further comprises a coordinator shard, which is updated by the coordinator module.

In some embodiments, the coordinator module is further comprised of one or more sub-coordinator modules operating in a hierarchical fashion.

In various embodiments, the coordinator module is configured to perform one or more of the following functions: evaluate a write operation to avoid a write collision, manage a set of read permissions, manage a set of write permissions, allocate data storage locations on the storage server, determine a data redundancy scheme, coordinate a data stripe length, coordinate a data stripe location, support a lock-free write operation, track a data storage location, or perform data compaction.

In certain embodiments, the storage drives further comprise a disk drive.

In some embodiments, one or more of the at least three storage nodes is a load balancer node or a deployment node.

In various embodiments, the datastore library implements a key-value store having a plurality of key-spaces, each key-space having one or more data structure shards.

In certain embodiments, the one or more data structure shards include a b+ tree shard.

In some embodiments, the datastore library includes one or more of an erasure encoding module, a compression module, an encryption module, a permissions module, a redundancy scheme module, a data stripe length module, a lock-free write module, or a data compaction module.

In various embodiments, the erasure encoding module is configured to perform a distributed erasure encoding process on data stored on one or more of the plurality of storage drives.

In certain embodiments, the datastore library is configured to perform a lock-free write function.

In some embodiments, the datastore library is configured to perform a read function.

In various embodiments, the datastore library is configured to determine when one or more of the plurality of storage drives has reached a write capacity threshold.

In certain embodiments, the datastore library is one of an object store database or a NoSQL database.

The present invention is further directed toward a method for creating a filesystem using a filesystem library in a distributed, scale-out data storage system. In some embodiments, the method includes the steps of establishing an expandable filesystem metadata key-space, adding an information node (inode) to the filesystem metadata key-space, including a reference to a data file stored on a storage device within the distributed, scale-out data storage system, the reference being generated from a filesystem metadata within the expandable filesystem metadata key-space.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified schematic illustration of a representative embodiment of a data storage system having features of the present invention;

FIG. 2 is a simplified schematic illustration of a representative embodiment of a distributed datastore for scale-out data storage systems; and

FIG. 3 is a simplified flowchart illustrating a representative operational implementation of a method for creating a filesystem using a filesystem library in a distributed, scale-out data storage system.

While embodiments of the present invention are susceptible to various modifications and alternative forms, specifics thereof have been shown by way of examples and drawings and are described in detail herein. It is understood, however, that the scope herein is not limited to the particular embodiments described. On the contrary, the intention is to cover modifications, equivalents, and alternatives falling within the spirit and scope herein.

### DESCRIPTION

Embodiments of the present invention are described herein in the context of a system and method that enables a data storage system, such as a distributed data storage system, to be utilized efficiently and effectively such that desired tasks can be performed within the storage system in an accurate and timely manner, with minimal waste of time, money, and resources. As described in detail in various embodiments herein, the present invention encompasses an incredibly adaptable data storage system and accompanying software, which are efficient, fast, scalable, cloud native, and well-suited for a data-driven future.

More particularly, the data storage systems described herein provide valuable solutions for unstructured data and are ideally suited for emerging high-growth use cases that require more performance and more scale, including AI and machine learning, modern data lakes, VFX and animation, and other high-bandwidth and high IOPS applications. In certain implementations, the data storage systems provide an all-flash, scale-out file, and object storage software platform for the enterprise. Leveraging advances in application frameworks and design that were not available even a few years ago, the modern cloud-native architecture of the present invention makes it an easy-to-use solution that overcomes the limitations of hardware-centric designs and enables customers to adapt to future storage needs while reducing the burden on over-extended IT staff.

It is appreciated that the data storage systems solve these challenges with an all-new scale-out architecture designed for the latest flash technologies to deliver consistent low-latency performance at any scale. These data storage systems introduce inline data services such as deduplication and compression, snapshots and clones, and metadata tagging to accelerate AI/ML data processing. Additionally, the data storage systems use familiar and proven cloud technologies, like microservices and open-source systems, for automating deployment, scaling, and managing containerized applications to deliver cloud simplicity wherever deployed.

In some embodiments, the software operates on standard high-volume flash storage servers enabling quick adoption of the latest hardware and storage infrastructure for future needs. In alternate embodiments, the optimizations disclosed can be utilized on myriad storage configurations including any combination of flash, hard disk drive (HDD), solid state drives (SSD) and the like. The data storage systems enable users to replace legacy disk-based storage systems with a software-defined performance suite, which is platform agnostic, and that provides faster performance, greater scale, and a more sustainable and green solution that is both power and real estate efficient.

The description of embodiments of the data storage systems is illustrative only and is not intended to be limiting. Other embodiments of the data storage system will readily suggest themselves to skilled persons having the benefit of this disclosure. Reference will now be made in detail to implementations of the data storage system as illustrated in the accompanying drawings. The same or similar reference indicators will be used throughout the drawings and in the following detailed description to refer to the same or like parts.

In the interest of clarity, not all routine features of the implementations described herein are shown and described. It will, of course, be appreciated that in the development of any such actual implementations, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming but would nevertheless be a routine undertaking of engineering for those of ordinary skill in the art having the benefit of this disclosure.

At a high level, embodiments of the present invention enable myriad efficiencies, which in turn increase speed, reliability, scalability, and flexibility. For example, the custom-built software suite enables at least the following, without limitation:
support for familiar key-value semantics such as GET, PUT, DELETE, SEARCH;
fast atomic transaction support;
copy-on write cloning support;
support for delta enumeration;
read scalability;
write scalability;
implementation in user space, kernel space, or a combination thereof;
zero-copy functionality;
flexible read caching; and
lock free writing.

The systems and methods disclosed integrate seamlessly into a variety of data storage system architectures, e.g., all flash, SSD, HDD, and combinations thereof. Embodiments are designed to deliver the same high-performance advantages in a platform-agnostic way. From a data storage operator's perspective, embodiments provide numerous advantages, including without limitation:
reduced expense;
enhanced customer choice and preference options;
reduction in single-source concerns and considerations;
flexibility in growing and evolving storage infrastructure without having to replace an entire storage infrastructure; and
enables use of public cloud IaaS.

It is appreciated by those skilled in the art that logic and algorithms are concepts or ideas that can be reduced to code, which in turn, can be packaged in modules or libraries. A “library” is a combination of executable computer code (logic) coupled with an interface. Modules and libraries, logic, code, and algorithms can be combined in programs, processes, Kubernetes pods, or servers to perform a specific purpose. Systems include programs, processes, Kubernetes pods, and servers running on nodes, clusters, or clouds to solve a particular problem. In embodiments described throughout, all modules and libraries are able to run in user space, the kernel or a combination of both.

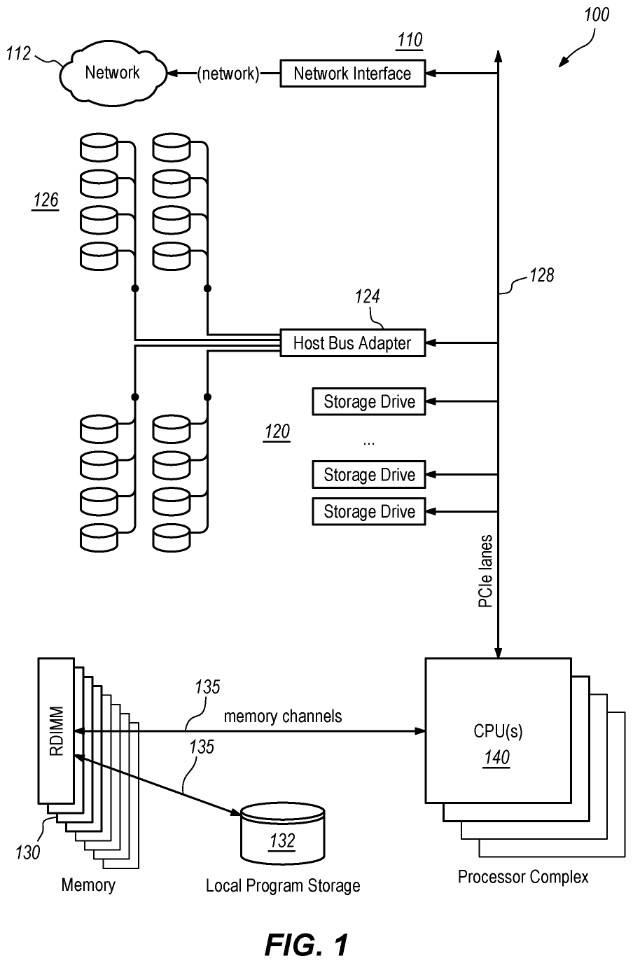

FIG. 1 is a simplified schematic illustration of a data storage system 100 upon which software innovations of a distributed datastore for a scale-out data storage system can be executed. The data storage system 100, when coupled with the software innovations of the distributed, scale-out data storage system, competes favorably with recent all-flash file and object storage solutions that rely on proprietary or esoteric hardware.

The data storage system 100 consists of a network interface 110. In one embodiment, the network interface 110 could be one or more remote direct memory access network interface controllers (RNIC). The network interface 110 provides connectivity to a network 112 and from there to an end user, e.g., a client computer, a machine learning module, an Artificial Intelligence (AI), an enterprise, and the like, as non-exclusive examples.

The data storage system 100 and associated software embodiments described herein work over any kind of presently known network 112, including personal area network (PAN), local area network (LAN), wireless local area network (WLAN), campus area network (CAN), metropolitan area network (MAN), wide area network (WAN), storage-area network (SAN), system area network (SAN), passive optical local area network (POLAN), enterprise private network (EPN), and virtual private network (VPN). Those of skill in the art will recognize the adaptability of what is taught herein as network development evolves over time.

Storage for the data storage system 100 can be, for example, and without limitation, one or more storage drives 120 devices. In an embodiment, the plurality of storage drives 120 includes non-volatile memory express (NVMe) flash drives, without limitation. In alternate embodiments, the data storage system 100 could include PCI attached storage. In an alternate embodiment, storage can include storage drives 126, which could be one or more disk drives 126. In embodiments, the one or more disk drives 126 could be, without limitation, such as a hard disk drive (HDD), hybrid hard drive (HHD), or solid-state drive (SSD) drives, or any combination thereof. In yet another embodiment, the data storage system 100 could use both storage drives 120 and one or more disk drives 126.

Connectivity for the components of the hardware platform 100 can be provided by a peripheral component interconnect express (PCIe) connection 128, which can also be referred to as PCIe lanes. Storage drives 126 could connect to the PCIe connection 128 through a host bus adapter (HBA) 124.

The data storage system 100 has a processor complex 140, which includes one or more computer processing units. The processor complex 140 executes the logic modules and libraries discussed further below.

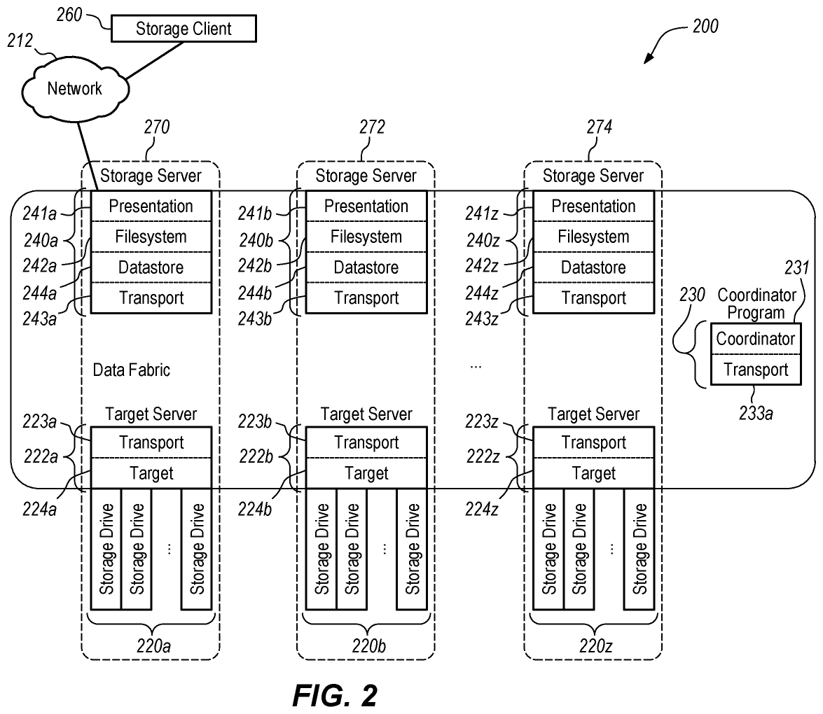

The data storage system 100 also has local memory storage capabilities in the form of memory devices 130 and local program storage 132. In certain embodiments, the logic modules and libraries, which will be discussed in more detail with reference to FIG. 2, that enable the functionality of the distributed datastore for scale-out storage can be stored in I memory devices 130, or in local program storage 132, or a combination of both. In an embodiment, memory devices 130 can include one or more registered dual inline memory modules (RDIMM) devices, as one non-exclusive example. The memory devices 130 are connected to local program storage 132 and processing complex 140 via memory channels 135.

FIG. 2 is a simplified schematic illustration of a distributed datastore 200 for the scale-out data storage system 100, sometimes referred to as “distributed datastore.” For illustrative purposes, some of the hardware aspects of the data storage system 100 have been depicted in FIG. 2 to provide clarity regarding the location of logic modules and libraries as well the tangible changes affected by those logic modules and libraries on the data storage system 100.

The distributed datastore 200 includes at least three storage nodes 270, 272, 274. Each storage node 270, 272, 274 includes a storage server 240a, 240b, and 240z, respectively, and a target server 222a, 222b, and 222z. Each of the storage nodes 270, 272, and 274 also has a plurality of storage drives 220a, 220b, 220z, respectively, attached to them. In an embodiment, storage drives 220a, 220b, 220z include NVMe flash drives, without limitation.

In an embodiment, one or more of storage nodes 270, 272, 274 is a load balancing node used to equally distribute data storage and IOPS within the data storage system. In an additional embodiment, one or more storage nodes 270, 272, 274 is a deployment node used to automate initialization management functions for the data storage system 100. Hardware communication within the data storage system 100 is accomplished among, for example, storage nodes 270, 272, 274, over data fabric 250.

The distributed datastore 200 is accessible by a storage client 260 through a network 212. In one embodiment, the storage client 260 can include a Network Attached Server (NAS) server and storage servers 240a, 240b, 240z can include a NAS server, as one non-exclusive example. The storage client 260 provides connectivity to the data storage system 100 enabling external clients (not shown) to access the data storage system 100. External clients can include, without limitation, individual computer systems, enterprises, Artificial Intelligence (AI) modules, or any other configurate enabled to run one or more of the networks 212 to perform typical data storage operations on the data storage system 100 using the distributed datastore 200.

In an embodiment, network 212 is a local area network (LAN). Those of skill in the art will recognize, in additional embodiments, network 212 includes, but are not limited to, personal area network (PAN), wireless local area network (WLAN), campus area network (CAN), metropolitan area network (MAN), wide area network (WAN), storage-area network (SAN), system area network (SAN), passive optical local area network (POLAN), enterprise private network (EPN), and virtual private network (VPN). Those of skill in the art will recognize the adaptability of what is taught herein as network development evolves over time.

Storage servers 270, 272, 274 include software modules and libraries used to manage the data storage system. Specifically, presentation layer 241a, 241b, 241z is a module of code stored in local program storage 132. Each presentation layer 241a, 241b, 241z can be configured to operate using a multitude of protocols, e.g., open source, proprietary, or a combination thereof, as non-limiting examples. By way of example, and without limitation, these protocols include Network File System (NFS), Server Message Block (SMB), Amazon Simple Storage Service (S3), and GUI enabled protocols.

Storage servers 270, 272, 274 also include transport libraries 243a, 243b, 243z. The transport libraries 243a, 243b, 243z enable the transfer of information from point-to-point within the distributed datastore 200. Transport libraries 243a, 243b, 243z form a communication infrastructure within the data storage system 100 and the distributed datastore 200. Transport libraries 243a, 243b, 243z provide a common API for passing messages between a server and a client end point, as those terms are generically used by those skilled in the art.

In one embodiment, transport libraries 243a, 243b, 243z remote direct memory access (RDMA). In another embodiment, transport libraries 243a, 243b, 243z use TCP/UNIX sockets. In embodiments, transport libraries 243a, 243b, 243z allow threads within the distributed datastore 200 to create queues and make connections. Transport libraries 243a, 243b, 243z move I/O requests and responses between initiators and targets. Transport libraries 223a, 223b, 223z and 233a, perform in the same fashion as described with regard to 243a, 243b, 243z, with one exception. Transport library 233a, which is part of coordinator program 230, is used to facilitate communication related to the tasks of the coordinator module 231.

Target servers 223a-223z also include a storage modules 224a-224z, respectively. Storage modules 224a-224z perform a lock-free multi-queue infrastructure for driving storage drives 220a-220z.

The coordinator program 230 includes a transport library 233a as well as a coordinator module 231. In an embodiment, the coordinator module 231 is a coordinator shard, which is updated by the coordinator module 231. While FIG. 2 depicts a single coordinator module 231, in some embodiments, there are sub-coordinator modules working in a hierarchical fashion under the direction of a lead coordinator module 231. The coordinator module 231, either on its own or in conjunction with the datastore library 244a-244z performs several data storage 100 management functions, including without limitation:
conflict resolution for operations such as writing data to the data storage system 100;
allocating space on storage drives 220a-220z for writing data;
determining a data redundancy scheme for data when it is written;
coordinating data stripe length and location;
supporting lock-free writing for data;
tracking data storage location;
coordinating access permissions for data reads such as what data can be accessed by which storage client 260 or ultimate end-user;
data compaction, also referred to by those skilled in the art as garbage collection; and
coordinate data write permissions, such as what data can be written by which storage client 260 or ultimate end user.

The datastore library 244a-244z, either on its own or in conjunction with the other modules and libraries within the distributed datastore 200 performs several data storage 100 management functions, including without limitation:
erasure encoding data;
encrypting data;
data deduplication;
compaction, also called garbage collection;
determining a delta enumeration of data snapshots; and
data compression.

In an embodiment, the datastore library 244a-244z implements a key-value store having a plurality of key-spaces, each key-space having one or more data structure shards. In an alternate embodiment, the data store library 244a-244z library implements a key-value store having a plurality of key-spaces, each key-space having one or more b+ tree shards. In one embodiment, datastore library 224a-224z is an object storage database. In another embodiment, datastore library 244a-z is a NoSQL database. In an embodiment, datastore library 244a-244z is a distributed, coherent key-value store specialized for applications like filesystem library 242a-242z.

In some embodiments, erasure encoding is a process involving writing data into zones and zone sets wherein the data is written in a distributed fashion in data stipes according to a data redundancy scheme. In embodiments, data is written in a loc-free fashion.

By way of background, a file system is a recursive structure of directories, also called “folders,” used to organize and store files, including an implicit top-level directory, sometimes called the “root directory.” Any directory in a file system can contain both files and directories, the number of which is theoretically without limit. Both directories and files have arbitrary names assigned by the users of the filesystem. Names are often an indication of the contents of a particular file.

Filesystems store data often at the behest of a user. Filesystems also contain metadata such as the size of the file, who owns the file, when the file was created, when it was last accessed, whether it is writable or not, perhaps its checksum, and so on. The efficient storage of metadata is a critical responsibility of a filesystem. The metadata of filesystem objects (both directories and files) are stored in inodes (short for “information nodes”). Inodes are numbered, which is all that is required to find them, and there are at least two types of inode: file inodes and directory inodes.

A file inode contains all metadata that is unique to a single file-all of the data listed above, and potentially many more, notably including an ordered list of blocks or extents where the data can be found. A directory inode contains metadata that is unique to a single directory-items such as who can add files or subdirectories, who can search the directory (e.g., to find an executable file), and notably, all of the names of the files, and subdirectories in the directory, each with its inode number.

With this abstraction, a filesystem basically comprises two kinds of data: inodes, which contain information about directories, and data files. Filesystems also contain information about the relationships between inodes and data files. Data files are typically written in data blocks, which are fixed size, or as data extents, variable length. The inodes store all of the metadata for all objects in the filesystem. Turning to filesystem library 242a-242z, in one embodiment, filesystem library 242a-242z is implemented as an application of a datastore library 244a-244z.

FIG. 2 depicts the distributed datastore 200 as being a unified collection of logic modules, libraries, storage, and interconnecting fabric. In alternate embodiments, each individual logic module or library within the distributed datastore 200 could be distributed across various interconnected hardware components, such as storage client 260 or other hardware devices connected to network 212, e.g., an individual computer system, a machine learning module, an AI module, and enterprise, a cloud, and the like. Those of skill in the art will recognize the infinite possibilities for distributing the components of the distributed, scale-out data storage system across myriad software, hardware, and firmware configurations.

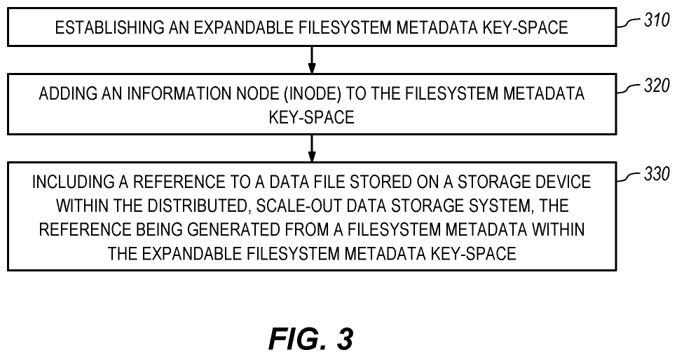

FIG. 3 shows a method for creating a filesystem using a filesystem library in a distributed, scale-out data storage system, the method comprising the steps of: establishing 310 an expandable filesystem metadata key-space; adding 320 an information node (inode) to the filesystem metadata key-space; and including 330 a reference to a data file stored on a storage device within the distributed, scale-out data storage system, the reference being generated from a filesystem metadata within the expandable filesystem metadata key-space. In embodiments, filesystem metadata can include inodes, directory entries, file size, file ownership, file creation date, last access date, write permissions for the file, file checksum, and the like.

It is understood that although a number of different embodiments of the systems and methods for key-value shard creation in a key-value store have been illustrated and described herein, one or more features of any one embodiment can be combined with one or more features of one or more of the other embodiments, provided that such combination satisfies the intent of the present technology.

While a number of exemplary aspects and embodiments of the systems and methods for key-value shard creation in a key-value store have been discussed above, those of skill in the art will recognize certain modifications, permutations, additions, and sub-combinations thereof. It is, therefore, intended that the following appended claims and claims hereafter introduced are interpreted to include all such modifications, permutations, additions, and sub-combinations as are within their true spirit and scope.

What is claimed is:

1. A distributed, scale-out data storage system comprising:
at least three storage nodes, each storage node further comprised of:
a storage server configured to connect to a storage client over a network interface;
a target server connected to a plurality of storage drives;
a processor complex; and
a memory, wherein the memory has a plurality of logic modules and a plurality of libraries stored thereon and executable by the processor complex to perform data storage management operations;
a coordinator program; and
a data fabric.

2. The distributed, scale-out data storage system of claim 1 wherein the plurality of storage drives are non-volatile memory express (NVMe) flash drives.

3. The distributed, scale-out data storage system of claim 1, wherein the storage server is further comprised of:
a presentation module;
a filesystem library;
a datastore library; and
a transport library.

4. The distributed, scale-out data storage system of claim 1 wherein the target server is further comprised of:
a storage module; and
a transport library.

5. The distributed, scale-out data storage system of claim 1 wherein the coordinator program is further comprised of:
a coordinator module; and
a transport library.

6. The distributed, scale-out data storage system of claim 1 wherein one or more of the plurality of logic modules or the plurality of libraries forms a Kubernetes pod.

7. The distributed, scale-out data storage system of claim 1, wherein the target module coordinates access to individual storage drives within the plurality of storage drives.

8. The distributed, scale-out data storage system of claim 1, wherein the coordinator module further comprises a coordinator shard, which is updated by the coordinator module.

9. The distributed, scale-out data storage system of claim 1, wherein the coordinator module is further comprised of one or more sub-coordinator modules operating in a hierarchical fashion.

10. The distributed, scale-out data storage system of claim 1, wherein the coordinator module is configured to perform one or more of the following functions:
evaluate a write operation to avoid a write collision;
manage a set of read permissions;
manage a set of write permissions;
allocate data storage locations on the storage server;
determine a data redundancy scheme;
coordinate a data stripe length;
coordinate a data stripe location;
support a lock-free write operation;
track a data storage location; or
perform data compaction.

11. The distributed, scale-out data storage system of claim 1, wherein the storage drives further comprise a disk drive.

12. The distributed, scale-out data storage system of claim 1, wherein one or more of the at least three storage nodes is a load balancer node or a deployment node.

13. The distributed, scale-out data storage system of claim 3 wherein the datastore library implements a key-value store having a plurality of key-spaces, each key-space having one or more data structure shards.

14. The distributed, scale-out data storage system of claim 13 wherein the one or more data structure shards include a b+ tree shard.

15. The distributed, scale-out system of claim 3 wherein the datastore library includes one or more of an erasure encoding module, a compression module, an encryption module, a permissions module, a redundancy scheme module, a data stripe length module, a lock-free write module, or a data compaction module.

16. The distributed, scale-out data storage system of claim 15, wherein the erasure encoding module is configured to perform a distributed erasure encoding process on data stored on one or more of the plurality of storage drives.

17. The distributed, scale-out data storage system of claim 3, wherein the datastore library is configured to perform a lock-free write function.

18. The distributed, scale-out data storage system of claim 3, wherein the datastore library is configured to perform a read function.

19. The distributed, scale-out data storage system of claim 3, wherein the datastore library is configured to determine when one or more of the plurality of storage drives has reached a write capacity threshold.

20. The distributed, scale-out data storage system of claim 3 wherein the datastore library is one of an object store database or a NoSQL database.

21. A method for creating a filesystem using a filesystem library in a distributed, scale-out data storage system, the method comprising the steps of:
establishing an expandable filesystem metadata key-space;
adding an information node (inode) to the filesystem metadata key-space;
including a reference to a data file stored on a storage device within the distributed, scale-out data storage system, the reference being generated from a filesystem metadata within the expandable filesystem metadata key-space.
